(19) United States
(12) Patent Application Publication
(10) Pub. No.: US 2016/0021907 A1
(43) Pub. Date: Jan. 28, 2016

(54) INKJET PRINTING WITH EDIBLE INK

(71) Applicant: NESTEC S.A., Vevey (CH)

(72) Inventors: Sandrine Cavin, Epalinges (CH); Christopher James Pipe, Lausanne (CH); Martin Michel, Lausanne (CH)

(73) Assignee: NESTEC S.A., Vevey (CH)

(21) Appl. No.: 14/774,270

(22) PCT Filed: Mar. 10, 2014
(86) PCT No.: PCT/EP14/54609

§ 371 Date: Sep. 10, 2015

(30) Foreign Application Priority Data
Mar. 11, 2013 (EP) 13158659.6

(51) Int. Cl. A23G 3/34; A23G 1/30; A23G 1/00; A21D 13/00; B41J 2/01; A21D 13/08

(52) U.S. Cl. CPC A23G 3/0097; B41J 2/01; A21D 13/08; A23G 1/0006; A21D 13/0016; A23G 3/343; A23G 1/305

(57) ABSTRACT

The present invention relates generally to printing processes. In particular the invention relates to processes for printing with edible inks. An aspect of the invention relates to printing an edible ink onto a material using an inkjet printing device. The material may be an edible material. The ink may comprise a colourant, at least 30% water, at least 25% carbohydrate sweeteners and be free from both diols and triols. A further aspect of the invention is a printed foodstuff obtainable by the process of printing edible ink onto a material.

The present invention relates generally to printing processes. In particular the invention relates to processes for printing with edible inks. An aspect of the invention relates to printing an edible ink onto a material using an inkjet printing device. The material may be an edible material. The ink may comprise a colourant, at least 30 wt. % water, at least 25 wt. % carbohydrate sweeteners and be free from both diols and triols. A further aspect of the invention is a printed foodstuff obtainable by the process of printing edible ink onto a material.

Inkjet printing technology is a reliable, quick and convenient method of printing digital images on a variety of surfaces. It has great potential as a method for decorating foodstuffs as it can produce high quality images without the need for printing plates or other applicators to touch the foodstuff which can lead to damage of fragile food items or present a contamination risk. One of the advantages of inkjet printing is that the printed image can be varied simply by sending a different electronic signal to the print-head, allowing different images to be printed on successive food items and so producing products with visual variety. The rapid change of image also facilitates production change-over when manufacturing printed seasonal product ranges and adapting text for multi-lingual markets.

However, inkjet printing on food surfaces is not very common. Inkjet inks need to have specific physical properties to function well both in the print-head and on the printed surface. It is difficult to prepare an ink entirely from food grade materials which has the correct viscosity, surface tension, smear resistance, solubility, stability and drying time.

The surface tension of the ink is the primary factor determining droplet formation and spreading on the substrate upon contact. Whilst there are a variety of colourant carrier materials which can be used for non-edible applications with varying surface tension characteristics, for edible inks the choice is limited. Water has a low viscosity and a high surface tension which may cause poor print quality when water is used as a carrier for colourants in inkjet inks. Water-based inks are generally incompatible with hydrophobic surfaces, for example the wax coating on sugar panned confectionery such as Smarties™ sugar panned chocolate beans. The high surface tension of aqueous inks makes “wetting” substrates more difficult. To alleviate this problem, surfactants may be added to lower the surface tension of aqueous inks. However these surfactants have the disadvantage of stabilizing foam formation. Any air bubbles in the ink can decrease the print quality by preventing drop formation at the print-head, causing drops to be misdirected or affecting the velocity of the drops leaving the print-head.

WO2006/023615 describes using propylene glycol (propane-1,2-diol) as a carrier, with surfactants added to adjust the surface tension. Glycerol (propane-1,2,3-triol) may be used in edible inkjet ink formulations to increase viscosity, as well as acting as a humectant to avoid nozzle drying. U.S. Pat. No. 7,842,319 discloses an inkjet ink comprising a food grade dye; at least about 90 wt. % propane-1,2-diol, propane-1,2,3-triol or a mixture thereof and no more than about 5 wt. % water. Higher boiling diols can be used as carriers, especially when ink-jet printing is performed at elevated jetting temperatures. US20100166934 describes the use of butane-1,3-diol and polyethylene glycols in edible ink formulations.

One approach to try and formulate edible water-based inkjet inks which adhere to hydrophobic surfaces is to add an adhesive agent to the ink. WO2004/081126 describes inkjet inks with water as the major component; an edible binder system such as shellac combined with polyvinylpyrrolidone; an adhesive agent such as dextrin or gum Arabic and a dye colourant. However, the inks also comprise propylene glycol (propane-1,2-diol), isopropyl alcohol and butanol to lower the surface tension to permit efficient printing and to reduce the drying time of the ink.

U.S. Pat. No. 5,711,791 describes continuous inkjet inks where the carrier is an ethanol/water mixture and where wetting agents such as phosphatidylcholine are added to permit printing on hydrophobic surfaces. However inks containing ethanol are not always desired due to the flammability of ethanol, particularly inks with a high level of ethanol for example where the ethanol is used as the carrier. Ethanol is also prohibited under various religious dietary laws.

Another approach to printing on a material with a hydrophobic surface is to modify the surface and make it more suitable for a particular ink. For example EP1526780 describes modifying the surface of an edible material with a high polarity water-based glaze to improve the printing with the low viscosity inks typically used in ink-jet printing. However, this adds manufacturing complexity and may lead to other problems, for example water-based glazes are more susceptible to losing their gloss in humid conditions.

An ink therefore is typically formulated to work on a specific surface type. In a factory where different materials are printed, handling a range of different inks to adapt to each surface type adds complexity and therefore cost. It would be an advantage to be able to print with edible inkjet inks which can be used on a variety of different surfaces.

Many consumers prefer to choose edible products which only contain ingredients that they themselves would use in preparing food, and so manufacturers generally try to reduce the number of food additives in products wherever possible. It would therefore be beneficial to be able to print on edible materials using inkjet inks which contain only familiar ingredients, so-called “kitchen cupboard” ingredients. Similarly it would be beneficial to be able to print on materials in contact with food using inkjet inks which contain only familiar ingredients, in particular where there is a risk of transfer of the ink into the food. For decorating foodstuffs it would be preferable to only use ingredients which are already contained in the food being printed. In particular there is a need to be able to print using inkjet ink compositions which do not contain triols such as propane-1,2,3-triol or diols such as propane-1,2-diol.

The object of the present invention is to improve the state of the art and to provide an improved solution to overcome at least some of the inconveniences described above, or at least to provide a useful alternative. Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The object of the present invention is achieved by the subject matter of the independent claims. The dependent claims further develop the idea of the present invention.

Accordingly, the present invention provides in a first aspect a process for printing on a material comprising applying an edible ink onto the material using an inkjet printing device, wherein the ink comprises a colourant, at least 30 wt. % water, at least 25 wt. % carbohydrate sweetener and the ink is free from both diols and triols. In a second aspect, the invention relates to a printed foodstuff obtainable by subjecting the foodstuff to the process of the invention.

Conventional inks behave differently on different surfaces. This is due to a number of factors, but the surface tension of the ink plays an important role. After hitting the surface of the substrate, ink drops normally either spread or contract depending on whether their surface tension is higher or lower than the surface energy of the substrate. A small amount of spreading can be beneficial, leading to an even image, but if the ink drops spread too much the image will become indistinct. A drop of ink which has a surface tension lower than the surface energy of the substrate will start to spread across the substrate surface. As it spreads the ink also dries, and so there comes a point where the ink has dried to the extent where its increased viscosity prevents it from spreading any more. On porous surfaces inks may also spread into the substrate. Conversely, an ink which has a surface tension higher than the surface energy of the substrate will tend to pull away from the surface and ball-up. As the ink drop dries, the area of the ink in contact with the surface reduces. This contraction of ink drops is undesirable as it leads to a reduced optical density of the image. A particular ink therefore is typically formulated to work on a specific surface type. Substrates with different surface energies typically require different inks to achieve good quality results. One way of preventing the spread or contraction of the ink-drops is to add volatile solvents so that the ink dries quickly. However, volatile solvents are not always desirable in edible materials.

The inventors surprisingly found that by including at least 25 wt. % of a carbohydrate sweetener in an ink formulation they were able to successfully print on a range of different surfaces using an inkjet printer. The process of the invention was able to produce good quality images on a variety of surfaces; hydrophobic and hydrophilic surfaces, either porous or non-porous. The ink drop size and shape was found not to change greatly on drying, regardless of the different surface types used. Without wishing to be bound by theory, the inventors believe that the carbohydrate sweeteners cause the ink to adhere to the substrate surface on contact, acting rather like glue. This, together with the viscosity increase due to the dissolved carbohydrate sweeteners, prevents the ink-drop from spreading or shrinking too much during drying.

However, carbohydrate sweeteners are known to cause an increase in measured surface tension when dissolved in water [A. Docoslis et al., Colloids and Surfaces B: Biointerfaces 19 (2), 147-162 (2000)]. The surface tension of the ink at the print-head is critical. If the surface tension is too low, the nozzle surface will flood, but if the surface tension is too high, the print-head will not jet. Typically diols and triols are used to reduce the surface tension in inks to allow successful printing. The inventors were surprised to find that, by using the ink formulation in the process of the invention, drop formation in the print-head was still acceptable and good quality images could be achieved without the need for diols and triols in the ink.

A problem encountered when trying to inkjet print using an ink free from diols and triols is that the ink dries at the print-head, especially when the printer is paused for a period of time. This dried ink causes blockages. Diols and triols act as humectants reducing the risk of the ink drying out at the print-head. The inventors were surprised to find that the presence of carbohydrate sweetener and water in the ink of the process of the invention avoided problems of drying at the print-head. The inventors found that the process of the invention may be consistent and reliable in operation, without requiring modification of the print-head or causing maintenance issues.

The invention thus may provide a desirable process for decorating edible materials, for example being able to produce printed foodstuffs which are more appealing to consumers who wish to avoid unfamiliar ingredients in their food such as diols and triols.

FIG. 1 shows the test design used in the printing trials

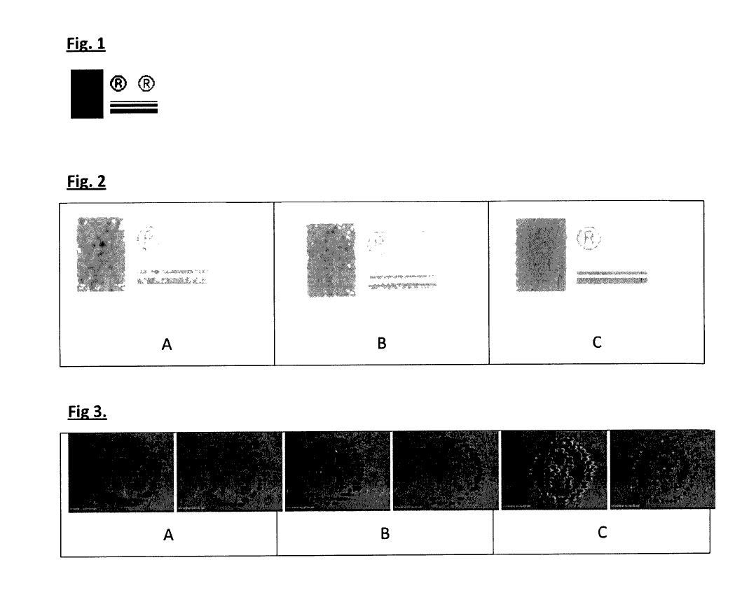

FIG. 2 shows designs printed on glass as observed with a Videometer multispectral imaging system; for inks A, B and C.

FIG. 3 shows the two trade mark symbols from the test design printed on glass as observed by the Dimatix DMP-2831 fiducial camera; for inks A, B and C.

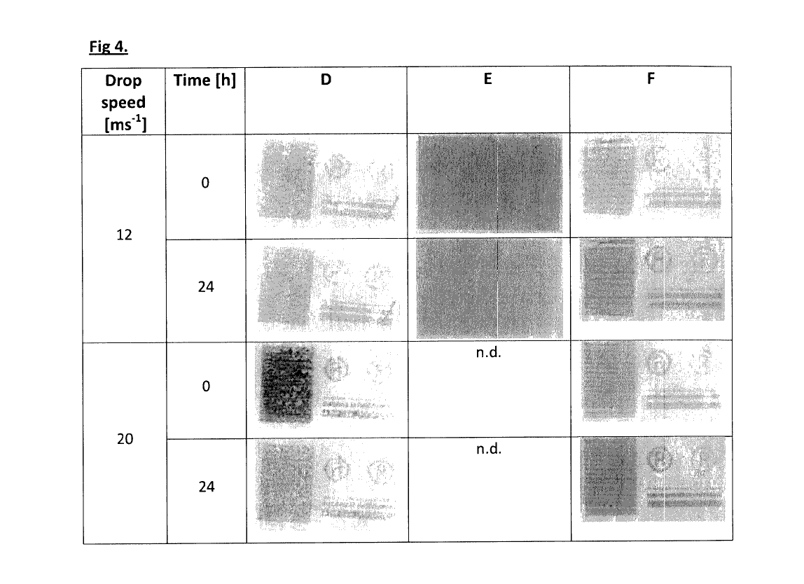

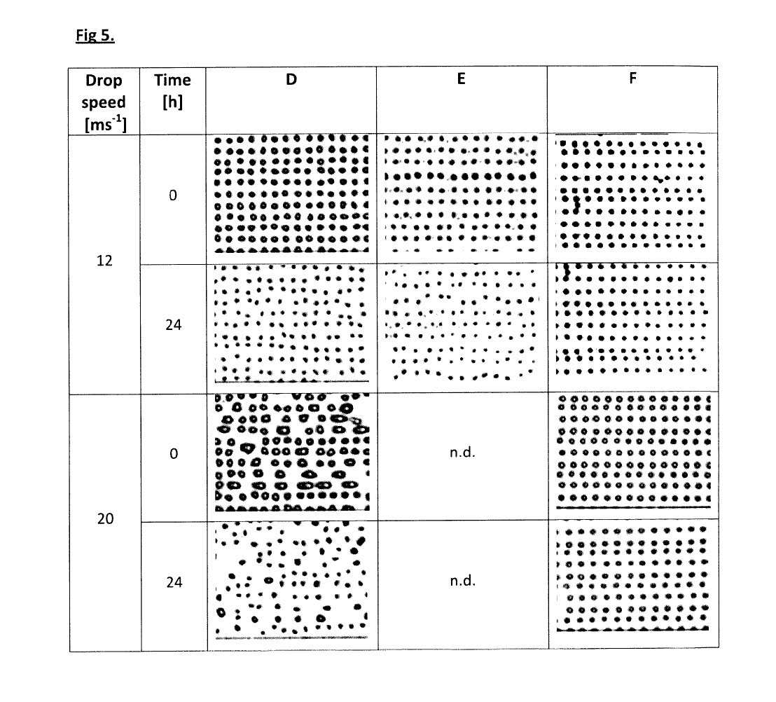

FIG. 4 shows designs printed on a wax film as observed with a Videometer multispectral imaging system; for inks D, E and F.

FIG. 5 shows designs printed on a wax film as observed by the Dimatix DMP-2831 fiducial camera; for inks D, E and F.

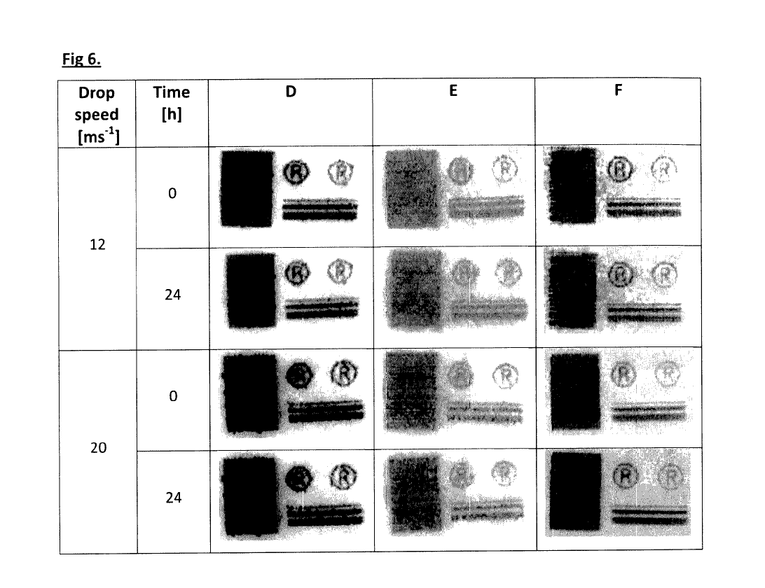

FIG. 6 shows designs printed on SMARTIES™ sugar panned confectionery as observed with a Videometer multispectral imaging system; for inks D, E and F.

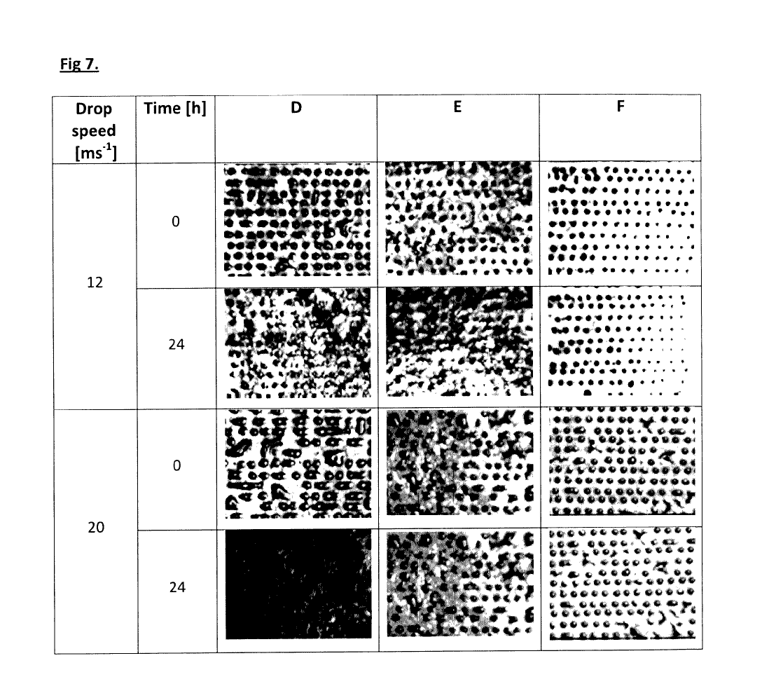

FIG. 7 shows designs printed on SMARTIES™ sugar panned confectionery as observed by the Dimatix DMP-2831 fiducial camera; for inks D, E and F.

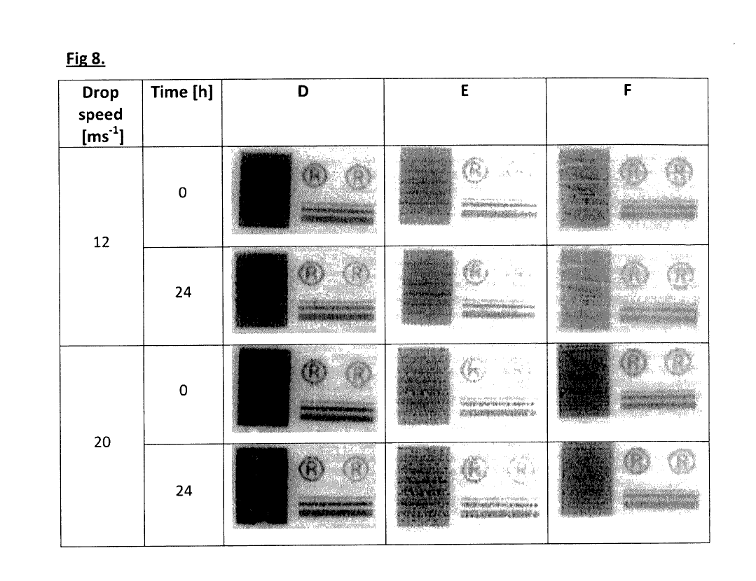

FIG. 8 shows designs printed on white chocolate as observed with a Videometer multispectral imaging system; for inks D, E and F.

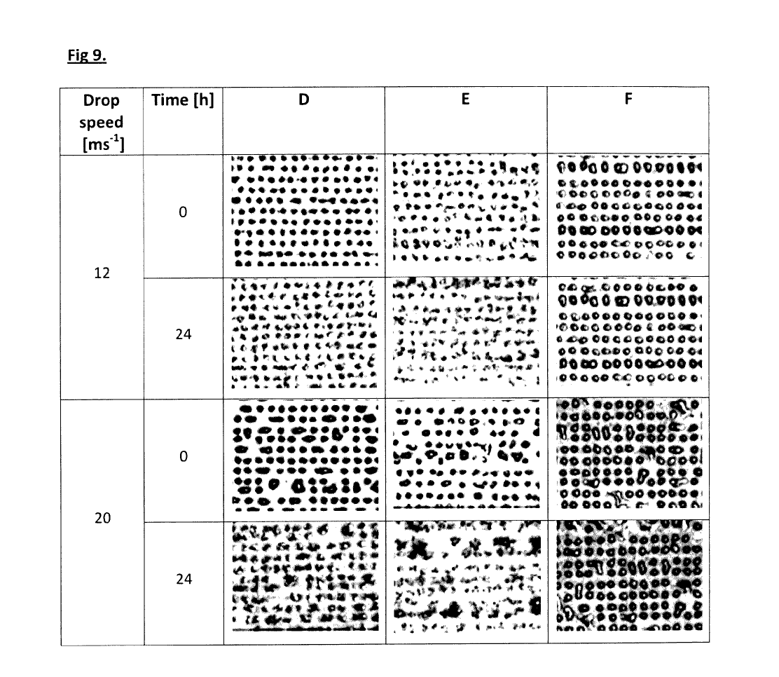

FIG. 9 shows designs printed on white chocolate as observed by the Dimatix DMP-2831 fiducial camera; for inks for inks D, E and F.

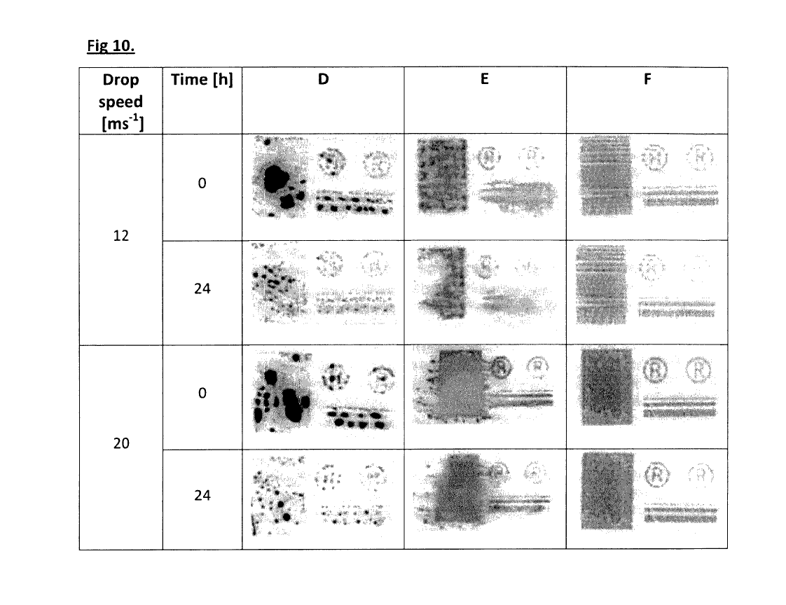

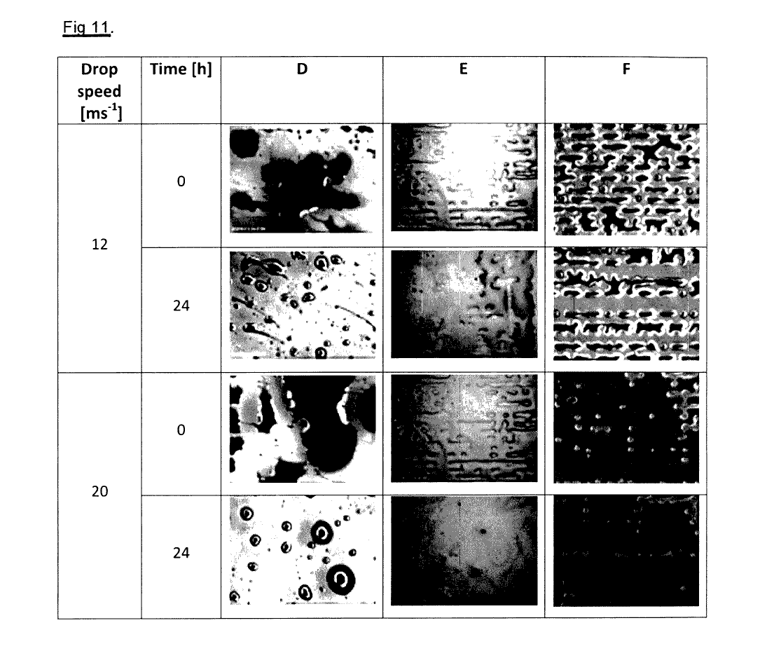

FIG. 10 shows designs printed on glass as observed with a Videometer multispectral imaging system; for inks D, E and F.

FIG. 11 shows designs printed on glass as observed by the Dimatix DMP-2831 fiducial camera; for inks for inks D, E and F.

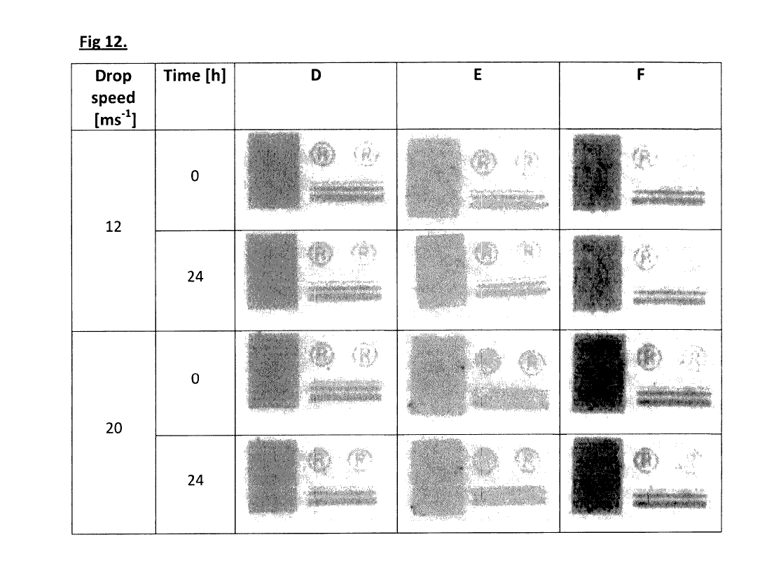

FIG. 12 shows designs printed on biscuit as observed with a Videometer multispectral imaging system; for inks D, E and F.

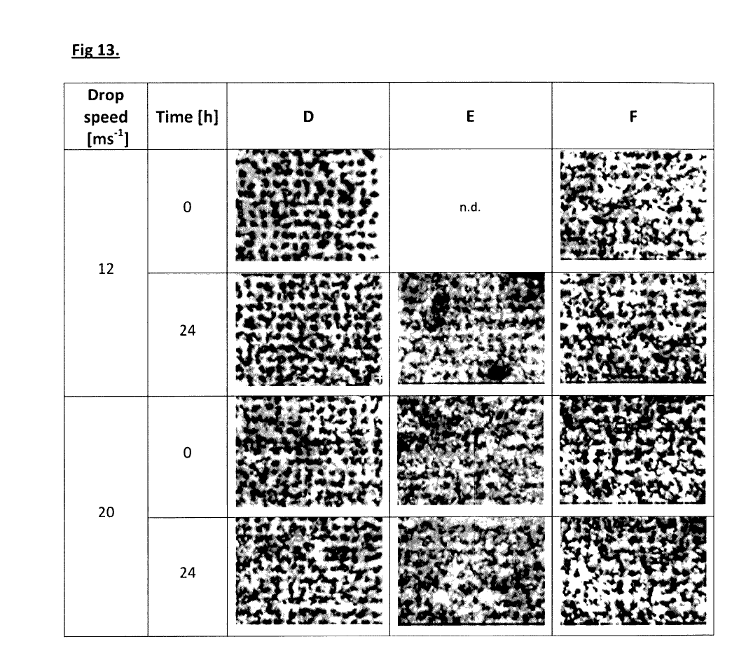

FIG. 13 shows designs printed on biscuit as observed by the Dimatix DMP-2831 fiducial camera; for inks for inks D, E and F.

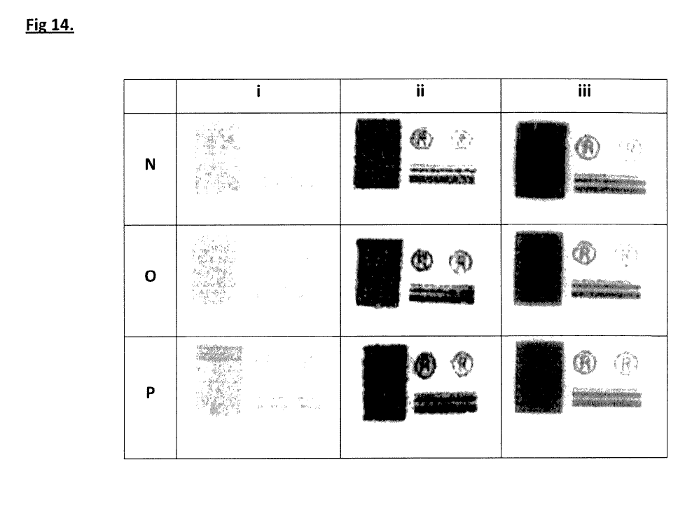

FIG. 14 shows designs printed on (i) glass, (ii) SMARTIES™ sugar panned confectionery and (iii) white chocolate as observed with a Videometer multispectral imaging system; for inks N, O and P.

Consequently the present invention relates in part to a process for printing on a material comprising applying an edible ink onto the material using an inkjet printing device, wherein the ink comprises a colourant, at least 30 wt. % water, at least 25 wt. % carbohydrate sweetener and the ink is free from both diols and triols.

Ink-jet printing systems are broadly divided into continuous inkjet (CIJ), and drop-on-demand (DOD) systems. In continuous jet systems, a high-pressure pump directs liquid ink from a reservoir through a gunbody and a microscopic nozzle, creating a continuous stream of ink. The stream is broken up into droplets, typically by a piezoelectric crystal, which creates an acoustic wave as it vibrates within the gunbody and causes the stream of liquid to break into droplets at regular intervals. To control the flow of ink droplets, the inks are electrostatically charged. The charged droplets are deflected by electrostatic deflection plates to a specific location on the substrate to create the desired character matrix, or are allowed to continue un-deflected to a collection gutter for recirculation. The more highly charged droplets are deflected to a greater degree. Only a small fraction of the droplets is used to print, the majority being recycled.

In drop-on-demand systems, droplets are generated as needed and projected at the substrate to create an image. Drop-on-demand systems are divided into thermal DOD and piezo DOD. In thermal DOD systems the print cartridges contain a series of tiny chambers, each containing a heater. To eject a droplet from a chamber, a pulse of current is passed through the heating element causing a rapid vaporization of the ink in the chamber to form a bubble. This causes a large pressure increase, propelling a droplet of ink onto the substrate. The ink's surface tension, as well as the condensation and contraction of the vapor bubble, pulls a further charge of ink into the chamber through a narrow channel attached to an ink reservoir. In contrast, piezo DOD systems have a piezoelectric material in the ink chamber behind each nozzle rather than a heating element. When a voltage is applied, the piezoelectric material changes shape, which generates a pressure pulse in the fluid forcing a droplet of ink from the nozzle.

The inkjet printing device in the process of the current invention may be any of the devices known in the art. For example, the inkjet printing device may be a drop-on-demand system or a continuous inkjet system. The inkjet printing device may be a piezo drop-on-demand system.

The term “edible” refers to substances which can be eaten safely. Whilst the current invention is not limited to substances permitted for consumption in any particular jurisdiction, edible inks may for example comprise materials approved for human consumption by the U.S. Food and Drug Administration. The colourant may be any edible coloured substance, for example a dye, a pigment or a plant extract. In the context of the current invention, coloured substances are those which absorb or reflect some or all of the wavelengths of light, and may include black or white substances. The colourant may be comprised with the carbohydrate sweetener, for example the brown colour in molasses.

The material to be printed by the process of the invention is not particularly limited. It is an advantage of the process of the present invention that it may be used to print hydrophobic or hydrophilic surfaces, either porous or non-porous. For example the process of the invention may be used to print a polypropylene film food wrapper, a chocolate product, a polished sugar coated dragee, a biscuit or edible rice paper such as is used in Vietnamese cuisine (bánh tráng). The process of the present invention may advantageously be used to apply edible ink onto food contact materials. These are materials which, although not intended to be eaten, are in contact with foods. For example it can be desirable to be able to print on the inside of packaging, as in some circumstances the inks on the inside of the package may transfer to the food. It is desirable for such inks to be edible.

The process of the present invention may be used to apply colours, patterns, images, logos or text onto the material. These may be to provide information about the nature of the material, for example to identify pharmaceutical tablets; or to decorate the material and make it more attractive, for example to print a cartoon character on a confectionery item, or to print a message on a paper wrapper surrounding a chocolate praline. The process of the invention provides good resolution of the images printed. For example the printing resolution may be at least 150 dots per inch (dpi), for example at least 300 dpi, for further example at least 500 dpi. The maximum resolution for the process of the invention depends on factors such as the design of the inkjet head, the exact ink composition and the substrate, but as an example, the maximum resolution may be 1200 dpi.

The process of the invention may be for printing on an edible material comprising applying an edible ink onto the edible material using an inkjet printing device, wherein the ink comprises a colourant, at least 30 wt. % water, at least 25 wt. % carbohydrate sweetener and the ink is free from both diols and triols. For example, the ink may comprise a colourant, at least 40% wt. water, at least 35 wt. % carbohydrate sweetener and be free from both diols and triols.

The edible material may be a foodstuff, for example a solid foodstuff. The foodstuff may be selected from the group consisting of confectionery products, for example biscuits including wafers; dough before baking; ice creams; cakes, including edible cake decorations; pet-food compositions; edible play items such as edible paper to be printed with a secret message; or nutritional supplements.

Carbohydrate sweeteners are sweet-tasting compositions wherein the molecules responsible for the sweetness consist of carbon, hydrogen and oxygen atoms. For example, fructose, glucose and sucrose are carbohydrate sweeteners, as is honey (which comprises fructose and glucose). Carbohydrate sweeteners are distinct from non-carbohydrate sweeteners which contain atoms other than carbon, hydrogen and oxygen and are generally chemically synthesized. Non-carbohydrate sweeteners typically have very high levels of sweetness intensity. Examples of non-carbohydrate sweeteners include sucralose (a chlorinated sugar), cyclamate (sodium N-cyclohexylsulfamate), saccharin (2H-1λ⁶,2-benzothiazol-1,1,3-trione), aspartame (N-(L-α-Aspartyl)-L-phenylalanine, 1-methyl ester) and acesulfame (potassium 6-methyl-2,2-dioxo-2H-1,2λ⁶,3-oxathiazin-4-olate). Suitable carbohydrate sweeteners of the present invention include, but are not limited to, sucrose; fructose; glucose; maltose; lactose; invert syrup (comprising fructose and glucose); honey; maple syrup (comprising sucrose); glucose syrups (hydrolysed starch syrups with DE>20); molasses (typically comprising sucrose, glucose and fructose); fruit juice concentrate; xylose; galactose; ribose; arabinose; rhamnose; and sugar alcohols, such as erythritol, xylitol, mannitol, sorbitol, isomalt, maltitol, lactitol or inositol.

Diols are chemical compounds with two hydroxyl groups, and triols are chemical compounds with three hydroxyl groups. Examples of diols include propane-1,2-diol (propylene glycol), butane-1,3-diol and polyethylene glycols; and propane-1,2,3-triol (glycerol) is an example of a triol. Although these materials may be safely consumed in edible materials within approved limits, some consumers would prefer to choose edible products which do not contain them. It is therefore an advantage that the invention provides a process capable of printing edible materials with the ink being free from both diols and triols. The term “free from both diols and triols” means that the total concentration of diols and triols in the ink is less than 0.01% by weight, for example less than 0.001% by weight, preferably completely absent.

The carbohydrate sweetener comprised within the ink of the process of the invention may be selected from the group consisting of monosaccharides, disaccharides, oligosaccharides, sugar alcohols and combinations of these. The carbohydrate sweetener may comprise monosaccharides and/or disaccharides. Many consumers prefer to eat edible materials made from ingredients from natural sources. The carbohydrate sweeteners may be obtained, for example obtainable, from natural sources; for example fructose, glucose, sucrose, maltose, lactose and sorbitol.

The carbohydrate sweetener may be selected from the group consisting of invert syrup, honey, maple syrup, glucose syrups, fruit juice concentrates, molasses and combinations of these. These materials are commonly used in the food industry as carbohydrate sweeteners and have good consumer acceptability. Invert syrup is a mixture of glucose and fructose, it is typically obtained by hydrolyzing sucrose to glucose and fructose. Honey is a sweet food made by bees. The main sugars in honey are glucose and fructose. Honey may contain particulate material and must be filtered before use in an inkjet printing ink. Maple syrup is a syrup made from the xylem sap of maple species. The main sugar in maple syrup is sucrose. It is beneficial to be able to use honey or maple syrup in an edible ink formulation as they have good consumer acceptability due to their long history of use and natural origins. In the context of the current invention the term “glucose syrups” is used in the confectionery sense, meaning hydrolysed starch syrups with a dextrose equivalent (DE) greater than 20. The term corn syrup is also commonly used to describe this material as it is often manufactured by the hydrolysis of corn (maize). Fruit juice concentrates are fruit juices where the water content has been reduced. Molasses is a viscous by-product of the refining of sugarcane into sugar. It is dark brown in colour which has the advantage that it can be used in an ink formulation as both a carbohydrate sweetener and colourant.

The carbohydrate sweetener may comprise at least two different saccharide compounds. For example the carbohydrate sweetener may comprise fructose and sucrose. By mixing saccharides in this way, a higher total weight of sweetener may be dissolved into solution. For example, 2.125 g sucrose can be dissolved in a gram of water at 25° C., but when sucrose is combined with glucose, 0.938 g glucose and 1.712 g sucrose can be dissolved per gram of water [R. F. Jackson et al., Natn. Bur. Stand. Tech. Paper 1924, No 259.277]. This is a total of 2.650 g of mixed saccharides in solution, compared with 2.125 g for the single saccharide. Having a higher quantity of carbohydrate sweetener in the ink provides a greater capacity for hydrogen bonding which may increase the ink's ability to stick to the substrate, but the viscosity of the ink does not increase, which is beneficial as such an increase might reduce performance in the print-head. Having at least two different saccharide compounds also reduces the tendency for the ink to crystallize on the print-head. Dissolving a higher weight of saccharides also reduces the water activity. The water activity of a food is a measure of the amount of unbound water available for microbial growth and chemical reactions. The at least two different saccharide compounds dissolved in water may therefore have a lower water activity for the same or similar viscosity. The lower water activity permits longer storage of the ink without growth of food spoilage organisms, so it is an advantage to be able to achieve this without an increase in viscosity which might prevent the ink from jetting correctly. Although many inkjet printers have the facility to heat the ink and so reduce its viscosity at the moment of jetting, it is preferable not to have to heat the ink to too high a temperature in case components of the ink, especially ingredients from natural sources, decompose. The ink may comprise at least 25% carbohydrate sweetener by weight, for example at least 45% carbohydrate sweetener by weight. The ink may comprise between 45 and 65% carbohydrate sweetener by weight.

At least 95 wt. % of the carbohydrate sweetener of the process of the invention may be a mixture of fructose, glucose and sucrose; with the ratio of sucrose to glucose being between 2.2:1 and 3.2:1 and the ratio of sucrose to fructose between 0.9:1 and 1.9:1. At least 95 wt. % of the carbohydrate sweetener of the process of the invention may be a mixture of sucrose and glucose with the ratio of sucrose to glucose being between 2.2:1 and 3.2:1. At least 95 wt. % of the carbohydrate sweetener of the process of the invention may be a mixture of fructose and glucose with the ratio of fructose to glucose being between 1.4:1 and 2.4:1. These compositions for the carbohydrate sweetener have been found to provide particularly good results in terms of both the ability to print on a variety of different surfaces and the ink's behavior in the print-head. The inks may be used without the need to add triols or diols to modify the surface tension or to prevent drying out. These compositions may also show a reduced tendency to crystallize on the print-head.

Ethanol is sometimes used in edible inkjet inks as a solvent as it kills bacteria giving the ink a long storage life, and it dries quickly on the substrate. It may also function as a surface tension modifier. However inks with a high level of ethanol have a number of disadvantages. Ethanol is flammable, presenting a safety risk, it can impart a bitter taste when incorporated in edible materials and some colourants precipitate in the presence of ethanol. The process of the current invention advantageously may use a water-based ink; that is an ink where the colourant and carbohydrate sweetener are carried in a solvent which is predominantly water. For example, the colourant and carbohydrate sweetener may be carried in a solvent which is at least 80% water. The process of the invention may apply an edible ink with a composition which has acceptable storage life and provides a good quality image on the substrate without the use of ethanol. However, in certain circumstances small amounts of ethanol may be incorporated in the ink formulation. For example, some colourants are supplied as a formulation together with ethanol, so the use of such colourants would lead to the incorporation of ethanol in the ink. The edible ink in the process of the invention may contain less than 20% ethanol by weight, for example less than 10% ethanol by weight, for further example less than 5% ethanol by weight. It is an advantage that the process of the present invention may use ink which is free from ethanol. For example such inks may be suitable for sale to Muslim consumers who do not consume ethanol.

Ethanol is not the only monohydric alcohol which may be encountered in edible materials; isopropyl alcohol (propan-2-ol) is sometimes used in ink formulations as a solvent and surface tension modifier. Isopropyl alcohol is not considered by consumers to be a familiar ingredient in edible materials and has many of the same disadvantages as ethanol, so it is an advantage to be able to formulate an edible ink without it. Fortunately, the process of the current invention may apply an edible ink which provides a good quality image on the substrate without the use of isopropyl alcohol. The ink of the process of the invention may be free from monohydric alcohols. Monohydric alcohols are alcohols with only one hydroxyl group.

The process of the invention may be for printing on an edible material comprising applying an edible ink onto the edible material using an inkjet printing device, wherein the ink comprises a colourant, at least 30 wt. % water, at least 25 wt. % carbohydrate sweetener and the ink is free from monohydric alcohols, diols and triols. For example, the ink may comprise a colourant, at least 40 wt. % water, at least 35 wt. % carbohydrate sweetener and be free from monohydric alcohols, diols and triols. Even when no monohydric alcohols, diols or triols are added to the composition as such, some colouring materials may be supplied with trace amounts of monohydric alcohols, diols or triols. The term “free from monohydric alcohols, diols and triols.” means that the total concentration of monohydric alcohols, diols and triols in the ink is less than 0.05% by weight, for example less than 0.005% by weight, preferably completely absent.

The ink of the process according to the invention may have a viscosity at 30° C. of between 3 and 40 mPa·s, for example between 7 and 36 mPa·s. The inventors have found that inks with viscosities in this range function particularly well and may be obtained in an ink comprising at least 30 wt. % water and at least 25 wt. % carbohydrate sweetener, without the need for the addition of diols or triols.

The ink of the process according to the invention may have a surface tension at 25° C. of between 20 and 65 mN/m, for example between 30 and 45 mN/m. The inventors have found that inks with surface tensions in this range function particularly well and may be obtained in an ink comprising at least 30 wt. % water and at least 25 wt. % carbohydrate sweetener, without the need for the addition of diols or triols.

The colourant of the process according to the invention may be a single ingredient, or may comprise a mixture of ingredients. For example, the colourant may be a mixture of two materials each with a different colour in order to obtain the desired shade. The colourant may comprise a coloured material together with further ingredients to maintain the desired colour, for example to control pH for pH sensitive materials, or to make the colour soluble in water. The colourant of the process according to the invention may be derived from natural sources. Many people are concerned about the safety of materials industrially synthesized from chemical feedstock, especially when these materials are to be ingested and prefer materials obtained from natural sources. The colourant may be a fruit, vegetable or plant extract. The colourant of the process according to the invention may be selected from the group consisting of annatto, carmine, copper chlorophyllin, spirulina, rice starch, vegetable carbon, betalains, anthocyanins, beta-carotenes, caramel, malt, paprika, lutein, turmeric and combinations of these. The colourant comprised within the ink of the process of the current invention may be present in an amount of at least 0.01% by weight, for example at least 0.1% by weight, for further example at least 1% by weight.

The water content of the ink of the process of the invention may be between 30 wt. % and 60 wt. % and the carbohydrate sweetener content of the ink may be between 40 and 70 wt. %. For example the water content of the ink of the process of the invention may be between 35 and 55 wt. % and the carbohydrate sweetener content of the ink may be between 45 and 65 wt. %. These composition values may provide a balance between reliable performance in the print-head and the ability to print on a variety of surfaces with good adhesion and little change in ink drop size and shape on drying. These compositions may also provide acceptable storage performance for the ink without growth of food spoilage organisms.

The ink compositions of the process of the invention adhere well to a range of different substrate types. The carbohydrate sweeteners and water together cause a stickiness which allows the ink to adhere to the printing substrate. This allows the process of the invention to successfully print the same ink formulation on a variety of surfaces. Although surfactants may be present in the ink, for example as a component of the colourant, their function is not essential in allowing the process to print well on different surfaces. The ink of the process of the invention may be free from surfactants. For example, the ink may be free from polysorbates, phospholipids, glycolipids, monoglyceride derivatives and fatty acid esters.

The ink compositions of the process of the invention also do not require the inclusion of gelatin as a binder in order to adhere well to a range of different substrate types. Gelatin is a mixture of peptides and proteins produced by partial hydrolysis of collagen extracted from the skin, bones, and connective tissues of animals such as domesticated cattle, chicken, pigs, and fish. Animal glues such as hide glue are essentially unrefined gelatin. Although commonly used in food products, gelatin is not suitable for vegetarians and is often avoided by consumers who follow religious dietary rules as they are unsure of the animal species from which the gelatin originates. The ink used in the process of the invention may be free from gelatin.

The ink of the process of the invention may consist of a colourant, at least 30 wt. % water and at least 25 wt. % of carbohydrate sweetener.

The material of the process of the invention may be a confectionery product, a dietary supplement tablet or capsule, a breakfast cereal, an ice cream or a cake. The edible ink may be applied in the process of the present invention at a resolution of at least 150 dots per inch (dpi), for example at least 300 dpi, for further example at least 500 dpi.

In a further embodiment, the present invention may be a printed foodstuff obtainable, for example obtained, by subjecting a foodstuff to the process of the invention. The printed foodstuff may have a printed image with a resolution of at least 150 dots per inch (dpi), for example at least 300 dpi, for further example at least 500 dpi. Printed foodstuffs with high resolution images may for example show photographs or complex logos.

The printed foodstuff according to the invention may be a confectionery product, a dietary supplement tablet or capsule, a breakfast cereal, an ice cream or a cake. The term confectionery products includes for example biscuits, such as filled biscuits, wafer biscuits or dog biscuits; fat based confectionery, such as chocolate; and sugar confectionery, such as sugar panned confectionery, pressed tablets or high-boiled sweets. A dietary supplement, also known as food supplement or nutritional supplement, is a preparation intended to supplement the diet and provide nutrients, such as vitamins, minerals, fiber, fatty acids, or amino acids, that may be missing or may not be consumed in sufficient quantities in a person or animal's diet. These may be formed into tablets or comprised within a capsule. It is an advantage to be able to print on a variety of different edible materials. Printing a foodstuff may provide an amusing decoration, such as printing the image of a pair of sunglasses on a sugar panned confectionery or a cartoon character on an extruded piece of breakfast cereal; it may be used to mark a product with branding, such as a trade mark printed on an ice-cream; or it may add information, such as an identifier on a dietary supplement tablet. The printed foodstuff according to the invention may be free from gelatin.

Those skilled in the art will understand that they can freely combine all features of the present invention disclosed herein. In particular, features described for the product of the present invention may be combined with the method of the present invention and vice versa. Further, features described for different embodiments of the present invention may be combined. Where known equivalents exist to specific features, such equivalents are incorporated as if specifically referred to in this specification. Further advantages and features of the present invention are apparent from the figures and non-limiting examples.

### EXAMPLES

### Example 1

### Inkjet Inks with and without Propane-1,2-Diol

Three inks with the same colourant content were formulated with and without propane-1,2-diol and/or carbohydrate sweeteners in the formulations. The ink compositions by weight were; A) 50% of aqueous carmine and 50% of propane-1,2-diol (Fluka, Germany); B) 50% of aqueous carmine, 45% of propane-1,2-diol (Fluka, Germany) and 5% of sucrose (Merck, Germany); and C) 50% of aqueous carmine, 32.75% of fructose (Fluka, Israel) and 17.25% of glucose (Merck, Germany). The aqueous carmine colour was CC-1000 WS from Chr. Hansen, Denmark.

The surface tension of each of these inks was measured using a tensiometer (Tensiometer K12 from Kruss, Germany) with Wilhelmy plate according to the following plate method. The liquid is raised until the contact between the surface or interface and the plate is registered. The maximum tension acts on the balance at this instant; this means that the sample does not need to be moved again during the measurement. The tension is calculated using the following equation

$$σ = \frac{F}{L \cdot cos θ}$$

where σ=surface or interfacial tension; F=force acting on the balance; L=wetted length; and θ=contact angle. The plate is made of roughened platinum and is optimally wetted so that the contact angle θ is virtually 0°. This means that the term cos θ has a value of approximately 1, so that only the measured force and the length of the plate need to be taken into consideration.

The measured surface tension values were respectively A) 31.1±0.6 mN/m; B) 31.3±0.6 mN/m; and C) 33.4±0.7 mN/m. The presence of carmine in the inks reduces surface tension. Ink B differs from ink A in that 10% of the propane-1,2-diol has been replaced by sucrose; this makes no real difference to the surface tension. However, ink C differs from ink A in that all the propane-1,2-diol has been removed and replaced by fructose and glucose; this leads to a small increase in surface tension.

The inks were filtered through a 0.2 μm filter Chromafil® PET-20/25 (Macherey-Nagel GmbH & Co. KG, Germany) and then immediately filled into printing cartridges DMC-11610 (Dimatix, USA). The cartridges were placed in an ultrasonic bath for 30 minutes in order to remove any dissolved gas, before being allowed to stand, with the nozzles facing down, for 30 minutes before use.

A test design (FIG. 1) was printed at 400 dpi with each of the ink formulations using a piezo-driven jetting device (FujiFilm Dimatix DMP-2831). The inks were printed onto glass microscope slides (Paul Marienfield GmbH & Co. KG, Germany) which had been cleaned in a 1N HCl bath overnight, rinsed 3 times with MilliQ water and then dried with lint-free wipes. The glass microscope slide provides an example of a hydrophilic non-porous surface. The same waveform and jetting frequency (5 KHz) were used for each ink. The jetting voltage and temperature were adjusted to regulate the drop speed to 20 ms⁻¹, listed below:

| Ink | Formulation | Jetting voltage [V] | Jetting temp. [° C.] |
|---|---|---|---|
| A | Carmine and PG | 28 | 40 |
| B | Carmine, PG, sucrose | 34 | 42 |
| C | Carmine, fructose, | 40 | 60 |
| | glucose | | |

The printed images were examined using a multispectral imaging system (VideometerLab (Videometer, Denmark) and the Dimatix DMP-2831 fiducial camera, as shown in FIGS. 2 and 3. It can be seen that the presence of 5% of carbohydrate sweetener (sucrose) in the diol-containing ink B improves the print quality. Surprisingly the diol-free ink formulation with 50 wt. % of carbohydrate sweeteners (fructose and glucose), ink C, was found to produce an even higher quality image and presented no technical problems to print.

### Example 2

### Inkjet Printing on Different Surfaces

A brown coloured ink (ink F) was prepared by mixing 4.55 g of aqueous carmine colour CC-1000 WS, 6.07 g of aqueous natural chlorophyll colour C-3000 WS, 4.55 g of aqueous annatto A-640 WS, 4.97 g of fructose, 2.64 g of glucose and 7.20 g of sucrose. The water content of ink F was 46% and the carbohydrate sweetener content 50.3% by weight. The colours were obtained from Chr. Hansen, Denmark.

Two commercial solvent-based inks which do not contain carbohydrate sweeteners were used as comparison, listed below.

| Ink | Name | Supplier | Batch/Lot |
|---|---|---|---|
| D | Model Fluid MFL-003 | Dimatix | M1216A |
| E | Food ink cyan | Sensient | PL4/77/B |

The inks were used to print on four different surface types:

Surface type

| | |
|---|---|
| Hydrophobic porous | Moulded white chocolate (Nestlé, Switzerland) |
| | SMARTIES ™ sugar panned confectionery |
| | (Nestlé, Germany) |
| Hydrophobic non-porous | Wax film, Capol ™1295 (Capol GmbH, |
| | Germany) |
| Hydrophilic porous | PASSATEMPO ™ biscuit (Nestlé Brazil) |
| Hydrophilic non-porous | Glass microscope slide |

Microscope glass slides were prepared as in Example 1. The white chocolate, SMARTIES™ sugar panned confectionery and PASSATEMPO™ biscuits were used as commercially supplied. The SMARTIES™ sugar panned sweets are finished with a wax polish to provide a glossy attractive surface. The PASSATEMPO™ biscuits used were the biscuit components of “Biscoito Recheado Sabor Chocolate Alpino”.

The wax film was formed by melting Capol™1295 (a mixture of white beeswax and carnauba wax) in a clean Petri dish at 120° C. The oven was allowed to cool slowly to room temperature, and a film of wax was formed on the bottom of the Petri dish. The wax film was removed from the Petri dish; the surface which had been in contact with the Petri dish glass was glossy and non-porous and provided the substrate for the printing tests.

Ink viscosities were analyzed at 30° C. using a Paar Physica MCR500 rheometer. A double gap geometry DG26.7 was used. The temperature was regulated at 30° C. with a peltier element and the waiting time prior proceeding to the measurement was 3 minutes. Measurement was performed in rotational mode in 3 steps as follows: Step 1—the shear rate was increased from 10-100 1/s using a logarithm ramp in two minutes and every 10 seconds a measurement was taken. Step 2—two measurements were taken at the shear rate of 100 1/s. Step 3—the shear rate was decreased from 100-10 1/s using a logarithm ramp over two minutes and every 10 seconds a measurement was taken. An average is taken and expressed in mPa·s. Ink viscosities and surface tensions measured for each of the inks are shown in the table below. The ink surface tensions were measured using as described in Example 1.

| Ink | Viscosity [mPa · s] | Surface tension [mN/m] |
|---|---|---|
| D | 11.8 | 31 (35° C.) |
| E | 5.1 | 36 (35° C.) |
| F | 16.9 | 37 (23° C.) |

The same test design as in Example 1 (FIG. 1) was printed at 400 dpi with each of the ink formulations using the same piezo-driven jetting device (FujiFilm Dimatix DMP-2831) and the same frequency and waveform as Example 1. The jetting voltage and temperature were adjusted to obtain drop speeds of 12 ms⁻¹ and 20 ms⁻¹ (observed using the Dimatix DMP-2831 drop watcher).

| Ink | Drop speed [ms⁻¹] | Voltage [V] | Temperature [° C.] |
|---|---|---|---|
| D | 12 | 25 | 30 |
| | 20 | 34 | 30 |
| E | 12 | 20 | 30 |
| | 20 | 29 | 30 |
| F | 12 | 23 | 40 |
| | 20 | 33 | 40 |

Pictures of the printed designs on different surfaces and with different drop speeds were taken immediately after printing, and after 24 hours, using a multispectral imaging system (Videometer, Denmark) and the inkjet printing system fiducial camera (Dimatix, USA).

### Printing on a Wax Film

Printing results for inks D, E and F are shown in FIG. 4 (multispectral imaging system) and FIG. 5 (fiducial camera). Ink E did not produce a clear print and so no image is shown for drop speed 20 ms⁻¹ and only part of the image (the solid rectangle) is shown for drop speed 12 ms⁻¹.

As the drop speed increases from 12 ms⁻¹ to 20 ms⁻¹, the drop size increases by approximately 14% which in turn increases the optical density of the image (see FIGS. 4 and 5). The drops of ink D coalesce at a drop speed of 20 ms⁻¹ which leads to a reduction in the clarity of the image, especially when large areas are printed. This effect is emphasized once the ink has fully dried after 24 hours.

The ink drop sizes on the wax film surface shrink over time which leads to a reduction in optical density. This effect is greater for the solvent-based inks D and E than for the aqueous ink comprising carbohydrate sweetener, ink F. For example at 12 ms⁻¹ the drop size average reduces from 30 μm to 18 μm over 24 hours for ink D, from 23 μm to 18 μm for ink E, and from 26 μm to only 25 μm for ink F. This demonstrates that the process of the invention may create ink drops whose size and shape do not change greatly on drying.

### Printing on SMARTIES™ Sugar Panned Confectionery

On SMARTIES' sugar panned sweets, good print quality is obtained with ink F, the aqueous ink comprising carbohydrate sweetener, and with ink D, one of the solvent-based inks. The print was slightly blurred for ink E, especially at faster drop speeds. Printing results for the three inks are shown in FIG. 6 (multispectral imaging system) and FIG. 7 (fiducial camera).

### Printing on White Chocolate

The rear surface of the white chocolate tablet was printed, in other words the surface not in contact with the mould during manufacture. The best print quality was observed with ink F at a drop speed of 20 ms⁻¹. Printing results for the three inks are shown in FIG. 8 (multispectral imaging system) and FIG. 9 (fiducial camera).

### Printing on Glass Microscope Slides

On the glass surface, the commercial solvent-based inks D and E did not give a recognisable image (they are not intended to be used on this surface). However, the aqueous ink with carbohydrate sweetener, ink F, gave surprisingly good results, especially at the higher drop speed. There was no change in the drop size and shape over the drying period. Without wishing to be bound by theory, this may be explained by the formation of hydrogen bonds between the carbohydrate sweetener and water which make the concentrated solution sticky, rather like glue. Printing results for the three inks are shown in FIG. 10 (multispectral imaging system) and FIG. 11 (fiducial camera).

### Printing on Biscuits

Biscuit was found to be a good surface for inkjet printing, its porosity and absorbency helping to avoid bleeding and spreading of the inks. Fast drying time is achieved due to the biscuit's absorbency by capillarity and diffusion. Drop size and shape is not greatly affected by drying. The three inks showed relatively similar results. Biscuits printed with the solvent based inks (D and E) showed slightly better results at a drop speed of 12 ms⁻¹; whereas with ink F, the aqueous ink comprising carbohydrate sweetener, the best result was obtained with a drop speed of 20 ms⁻¹. Printing results for the three inks are shown in FIG. 12 (multispectral imaging system) and FIG. 13 (fiducial camera).

Overall, the edible aqueous inkjet ink with carbohydrate sweetener but no diols or triols (ink F) showed a remarkable ability to print on a variety of different surfaces. The ink drop size and shape was found not to change greatly on drying, regardless of the different surface types used.

### Example 3

### Inkjet Printing with Different Carbohydrate Sweetener Blends

Four inks were prepared with different carbohydrate sweetener compositions, all having a total of about 55.5% carbohydrate sweetener and about 44% water by weight, see table below.

| Ingredients (% by weight) | Ink G | Ink H | Ink I | Ink J |
|---|---|---|---|---|
| Aqueous annatto A-640 WS | 40 | 40 | 40 | 40 |
| (CHr Hansen, Denmark) | | | | |
| Added water | 4.4 | 4.45 | 4.15 | 4.15 |
| Fructose | 18.7 | 36.4 | — | — |
| Sucrose | 27 | — | 40.9 | 55.85 |
| Glucose | 9.9 | 19.15 | 14.95 | — |
| Ratio Sucrose:Glucose | 2.7:1 | | 2.7:1 | |
| Ratio Sucrose:Fructose | 1.4:1 | | | |
| Ratio Fructose:Glucose | 1.9:1 | 1.9:1 | | |

A test design was printed at 400 dpi with each of the ink formulations using a piezo-driven jetting device (FujiFilm Dimatix DMP-2831). The inks were printed onto PASSATEMPO™ biscuits. All inks produced a printed image. The inks' water activities (A_{w}) were measured using a Decagon Serie3 (AquaLab, US); and their viscosities (η) and surface tension values (σ) were measured as in Example 2. These values are listed in the table below, together with an assessment of how well the ink functioned at the print-head; for example, did all nozzles fire reliably, was the ink well absorbed by the cleaning pad?

| | Ink G | Ink H | Ink I | Ink J |
|---|---|---|---|---|
| | (Fruc/Gluc/Suc) | (Fruc/Glu) | (Gluc/Suc) | (Suc) |
| Aw | 0.88 | 0.85 | 0.89 | 0.90 |
| η at 30° C. | 23.2 | 19.2 | 31.3 | 37.4 |
| [mPa · s] | | | | |
| σ at 25° C. | 35.2 | 35.2 | 34.9 | 33.5 |
| [mN/m] | | | | |
| Printing | Moderate | Good | Moderate | Poor |
| behaviour at | | | | |
| print-head | | | | |

The results show that, for the same amount of carbohydrate sweetener, having at least two different saccharide components is beneficial. It reduces the viscosity which has the advantage of improving print-head performance and also reduces the water activity, which has the advantage of improving the storage properties of the ink.

### Example 4

### Inkjet Printing with Different Levels of Mixed Carbohydrate Sweetener

Four inks were prepared with different levels of carbohydrate sweetener compositions, all with the same ratio of fructose, glucose and sucrose as for ink G in Example 3.

| Ingredients (% by weight) | Ink K | Ink G | Ink L | Ink M |
|---|---|---|---|---|
| Aqueous annatto A-640 WS | 40 | 40 | 40 | 40 |
| (CHr Hansen, Denmark) | | | | |
| Added water | 1.2 | 4.4 | 7.4 | 9.4 |
| Fructose | 19.75 | 18.7 | 17.7 | 17 |
| Sucrose | 28.6 | 27 | 25.5 | 24.6 |
| Glucose | 10.45 | 9.9 | 9.4 | 8.9 |
| Total water (%) | 38.0 | 41.3 | 44.3 | 46.5 |
| Total carbohydrate sweetener (%) | 58.8 | 55.6 | 52.6 | 50.5 |

The inks' water activities (A_{w}), viscosities (η) and surface tension values (σ) are listed in the table below, together with an assessment of how well the ink functioned at the print-head.

| | Ink K | Ink G | Ink L | Ink M |
|---|---|---|---|---|
| Aw | 0.86 | 0.88 | 0.90 | 0.91 |
| η at 30° C. | 36.4 | 23.2 | 15.5 | 14.1 |
| [mPa · s] | | | | |
| σ at 25° C. | 36.2 | 35.2 | 34.9 | 33.5 |
| [mN/m] | | | | |
| Printing | Poor | Moderate | Good | Good |
| behaviour at | | | | |
| print-head | | | | |

All four inks produced acceptable printed images, but as the water content of the ink increases, the viscosity decreases and so the ink functions better at the print-head. However, this increase in water content raises the water activity, making the ink more prone to microbiological growth.

### Example 5

### Inkjet Printing with Different Levels of Single Carbohydrate Sweetener

Three inks were prepared with Annatto A-640 WS aqueous colourant (Chr Hansen, Denmark) and with sucrose as the carbohydrate sweetener. The sucrose was present at levels of 10%, 30% and 40% in the final formulation by weight. Compositions and measured viscosities are shown below.

| | | | Overall | Overall | |
|---|---|---|---|---|---|
| | | | carbohydrate | water | Viscosity |
| | Annatto | | sweetener | content | at 30° C. |
| | A-640 WS [g] | Sucrose [g] | [%] | [%] | [mPa · s] |
| Ink N | 3.0 | 0.334 | 10 | 83.4 | 1.6 |
| Ink O | 3.0 | 1.268 | 30 | 64.9 | 4.1 |
| Ink P | 3.0 | 2 | 40 | 55.6 | 8.1 |

The inks were printed with a drop speed of 15 m/s at 400 dpi. The test design and printer were the same as in Example 1. The same waveform and jetting frequency were applied for each ink, but the jetting voltage and temperature were adapted to obtain a drop speed of 15 m/s.

| | Drop speed | | |
|---|---|---|---|
| | [m/s] | Voltage [V] | Temperature [° C.] |
| Ink N | 15 | 25 | 30 |
| Ink O | | 25 | 45 |
| Ink P | | 27 | 50 |

The test design was printed on (i) a glass microscope slide, (ii) a SMARTIES™ sugar panned confectionery, and (iii) a moulded white chocolate. All surfaces were prepared as in Example 2. Pictures of the results on the different surfaces, obtained using a multispectral imaging system (Videometer, Denmark) are shown in FIG. 14. All three inks produced an image, but the image quality for Ink N, which had only 10% carbohydrate sweetener, was poor. Ink P, with 40% carbohydrate sweetener, produced the best images, and was able to print well on all three surfaces.

1. Process for printing on a material comprising applying an edible ink onto the material using an inkjet printing device, wherein the ink comprises a colorant, at least 30 wt. % water, at least 25 wt. % carbohydrate sweetener and the ink is free from both diols and triols.

2. A process according to claim 1 wherein the material is an edible material

3. A process according to claim 1 wherein the carbohydrate sweetener is selected from the group consisting of monosaccharides, disaccharides, oligosaccharides, sugar alcohols and combinations thereof.

4. A process according to claim 1 wherein the carbohydrate sweetener comprises at least two different saccharide compounds.

5. A process according to claim 1 wherein the ink is free from monohydric alcohols.

6. A process according to claim 1 wherein the viscosity of the ink at 30° C. is between 3 and 40 mPa·s.

7. A process according to claim 1 wherein the colorant is derived from natural sources.

8. A process according to claim 1 wherein the colorant is selected from the group consisting of annatto, carmine, copper chlorophyllin, spirulina, rice starch, vegetable carbon, betalains, anthocyanins, beta-carotenes, caramel, malt, paprika, lutein, turmeric and combinations thereof.

9. A process according to claim 1 wherein the water content of the ink is between 30 wt. % and 60 wt. % and the carbohydrate sweetener content of the ink is between 40 and 70 wt. %.

10. A process according to claim 1 wherein: at least 95 wt. % of the carbohydrate sweetener is a mixture of fructose, glucose and sucrose; and the ratio of sucrose to glucose is between 2.2:1 and 3.2:1 and the ratio of sucrose to fructose is between 0.9:1 and 1.9:1.

11. A process according to claim 1 wherein at least 95 wt. % of the carbohydrate sweetener is a mixture of sucrose and glucose and the ratio of sucrose to glucose is between 2.2:1 and 3.2:1.

12. A process according to claim 1 wherein at least 95 wt. % of the carbohydrate sweetener is a mixture of fructose and glucose and the ratio of fructose to glucose is between 1.4:1 and 2.4:1.

13. A process according to claim 1 wherein the ink consists of a colorant, at least 30 wt. % water and at least 25 wt. % of carbohydrate sweetener.

14. Printed foodstuff obtainable by subjecting a foodstuff to a process for printing on a material comprising applying an edible ink onto the material using an inkjet printing device, wherein the ink comprises a colorant, at least 30 wt. % water, at least 25 wt. % carbohydrate sweetener and the ink is free from both diols and triols.

15. A printed foodstuff according to claim 14 wherein the foodstuff is selected from the group consisting of a confectionery product, a dietary supplement tablet or capsule, a breakfast cereal, an ice cream and a cake.
